(19) United States
(12) Patent Application Publication
(10) Pub. No.: US 2023/0224554 A1
(43) Pub. Date: Jul. 13, 2023

(54) METHOD AND APPARATUS FOR WIRE FORMATS FOR SEGMENTED MEDIA METADATA FOR PARALLEL PROCESSING IN A CLOUD PLATFORM

(71) Applicant: TENCENT AMERICA LLC, Palo Alto, CA (US)

(72) Inventor: Iraj SODAGAR, Los Angeles, CA (US)

(73) Assignee: TENCENT AMERICA LLC, Palo Alto, CA (US)

(21) Appl. No.: 17/991,530

(22) Filed: Nov. 21, 2022

Related U.S. Application Data
(60) Provisional application No. 63/298,922, filed on Jan. 12, 2022.

(51) Int. Cl. H04N 21/845; H04N 21/84; G06F 16/787

(52) U.S. Cl. CPC H04N 21/845; H04N 21/84; G06F 16/787

(57) ABSTRACT

A method performed by at least one processor includes segmenting a media stream into a plurality of media segments in a multidimensional space. The method includes determining respective metadata associated with each of the plurality of media segments. The method includes encapsulating a plurality of metadata into a predetermined wire format, each encapsulated metadata comprising a location or sequence associated with the each of the plurality of media segments. The method includes parallel processing the plurality of media segments based on the encapsulated metadata. The method further includes merging, after the parallel processing, the plurality of media segments into the media stream.

### CROSS-REFERENCE TO RELATED APPLICATION

This application is based on and claims priority to U.S. Patent Application No. 63/298,922, filed on Jan. 12, 2022, the disclosure of which is incorporated herein by reference in its entirety.

### TECHNICAL FIELD

The present disclosure relates generally to wire formats, and more particularly to methods and apparatuses for wire formats for segmented media metadata for parallel processing in a cloud platform.

### BACKGROUND

The network-based media processing (NBMP) framework defines the interfaces including both data formats and application programming interfaces (APIs) among entities connected through digital networks for media processing. The NBMP standard defines a set of tools for the independent processing of media segments. The framework enables dynamic creation of media processing pipelines, as well as access to processed media data and metadata in real-time or in a deferred manner. The network and cloud platform are used to run various applications. While metadata parameters are defined, no interoperable wire format is defined for the segment metadata in the NBMP standard.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

According to an exemplary embodiment, a method performed by at least one processor includes segmenting a media stream into a plurality of media segments in a multidimensional space. The method includes determining respective metadata associated with each of the plurality of media segments. The method includes encapsulating a plurality of metadata into a predetermined wire format, each encapsulated metadata comprising a location or sequence associated with the each of the plurality of media segments. The method includes parallel processing the plurality of media segments based on the encapsulated metadata. The method further includes merging, after the parallel processing, the plurality of media segments into the media stream.

According to an exemplary embodiment, an apparatus including at least one memory configured to store computer program code, and at least one processor configured to read the computer program code and operate as instructed by the computer program code, the computer program code includes segmenting code configured to cause the at least one processor to segment a media stream into a plurality of media segments in a multidimensional space. The computer program codes includes determining code configured to cause the at least one processor to determine respective metadata associated with each of the plurality of media segments. The computer program code includes encapsulating code configured to cause the at least one processor to encapsulate a plurality of metadata into a predetermined wire format, each encapsulated metadata comprising a location or sequence associated with the each of the plurality of media segments. The computer program code includes parallel processing code configured to cause the at least one processor to parallel process the plurality of media segments based on the encapsulated metadata. The computer program code further includes merging code configured to cause the at least one processor to merge, after the parallel processing, the plurality of media segments into the media stream.

According to an exemplary embodiment a non-transitory computer readable medium having instructions stored therein, which when executed by a processor cause the processor to execute a method that includes segmenting a media stream into a plurality of media segments in a multidimensional space. The method includes determining respective metadata associated with each of the plurality of media segments. The method includes encapsulating a plurality of metadata into a predetermined wire format, each encapsulated metadata comprising a location or sequence associated with the each of the plurality of media segments. The method includes parallel processing the plurality of media segments based on the encapsulated metadata. The method further includes merging, after the parallel processing, the plurality of media segments into the media stream.

Methods, apparatuses, and non-transitory computer-readable mediums for wire formats for segmented media metadata for parallel processing in a cloud platform are disclosed by the present disclosure.

Additional embodiments will be set forth in the description that follows and, in part, will be apparent from the description, and/or may be learned by practice of the presented embodiments of the disclosure.

### BRIEF DESCRIPTION OF THE DRAWINGS

The above and other aspects, features, and aspects of embodiments of the disclosure will be apparent from the following description taken in conjunction with the accompanying drawings, in which:

FIG. 1 is a diagram of an example network-based media processing (NBMP) architecture, in accordance with various embodiments of the present disclosure.

FIG. 2 is a diagram of a splitter and merger template in a NBMP architecture, in accordance with various embodiments of the present disclosure.

FIG. 3 is an example of segment location metadata as a JavaScript Object Notation (JSON) object, in accordance with various embodiments of the present disclosure.

FIG. 4 is an example of segment sequence metadata as a JSON object, in accordance with various embodiments of the present disclosure.

FIG. 5 a flow chart of an example process for segmenting and processing a media stream using a wire format for the media stream metadata, in accordance with various embodiments of the present disclosure.

FIG. 6 illustrates an example computer system, in accordance with various embodiments of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

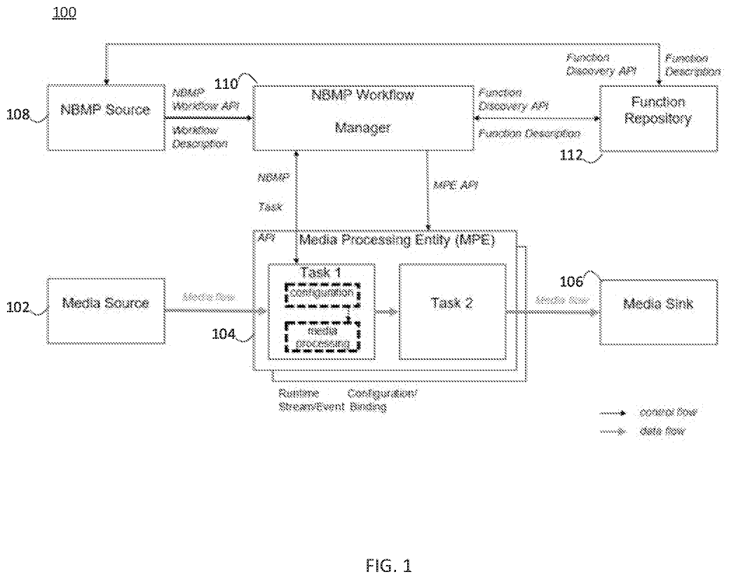

Embodiments of the present disclosure are directed to wire formats for the segmented media metadata used in the NBMP processing of the media segments. FIG. 1 illustrates an embodiment of an NBMP reference architecture (100). The NBMP reference architecture (100) may include a media source 102 that may provide a media flow (e.g., media stream) to a media processing entity (MPE) (104). The MPE (104) also may provide the media flow to a media sink (106).

The reference architecture (100) may further include a NBMP source (108) that provides a NBMP workflow API and workflow description to a NBMP workflow manager (110). The NBMP workflow manager (110) may receive an NBMP task from MPE (104), and provide a MPE API to the MPE (104). The reference architecture (100) may further include a function repository (112) that interacts with the NBMP source (108) and the NBMP workflow manager (110).

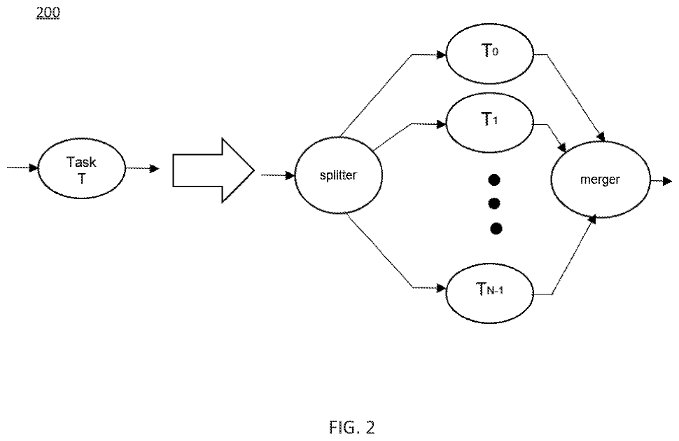

FIG. 2 illustrates an example of a splitter and merger function template defined in the NBMP standard. The splitter and merger function may be used for parallel processing of the segments. The media stream may be continuous. However, the splitter function may convert the media stream to N media sub-streams. Each sub-stream may be processed by an instance of T, and then the sub-streams interleaved together to generate the output (e.g., equivalent of Task T) stream.

1:N splitter and N:1 merger functions may work on the segment boundaries. Each segment may have (i) a start, (ii) duration, and (iii) length metadata, or (i) a start code and (ii) a sequence number associated with the segment. Since the segments are independent, consequently the sub-streams are independent of each other in terms of being processed by Task T. In some embodiments, Task T₀, . . . TN₋₁, do not need to process the segments at the same time. Since the segments and sub-streams are independent, each instance of Task may run at speeds independent of each other (e.g., each instance of the Task may run at its own speed). The conventional NBMP standard only addresses the 1-D segmentation of the media data.

According to some embodiments, each segment may use one of the following metadata:
1. The location metadata:
   a. Scaling vector T=[t₀, t₁, . . . , t_{M-1}], the scale factors for S and D,
   b. Starting vector S=[s₀, s₁, . . . s_{M-1}] representing the starting point of the media segment in M dimensional space with each index sᵢ in the unit tᵢ,
   c. Length vector D=[d₀, d₁, . . . , d_{M-1}] representing the hyperspace the media segment covering in M dimensional space with each index dᵢ in the unit tᵢ, and
   d. The size of segment L in bytes.
2. Or, the sequence metadata:
   a. Sequence vector n=[n₀, n₁, . . . n_{M-1}] representing the sequence of the media segment in M dimensional space with each index nᵢ,
   b. Startcode C, a unique code that every segment starts with, and the code is not repeated in the middle of any segments, and
   c. The size of segment L in bytes.

The NBMP standard doesn't define the wire format for the above metadata.

According to some embodiments, a wire format for metadata of one or more segments may include a byte stream format for location metadata and/or sequence metadata. The byte stream format may include an associated multipurpose internet mail extension (MIME). According to some embodiments, a wire format for metadata of one or more segments may include a JavaScript Object Notation (JSON) format for location metadata and/or sequence metadata. The JSON format may include an associated MIME.

According to some embodiments, the parameters C, S, D, and T are defined as follows. C may be a vector [c₀, c₁, . . . , c_{M-1}] with M dimension, with element cᵢ with index i, where index i+1 is nested in index i, which means one increment of index i of the vector is considered a larger increase than any increment in indices i+1, i+2, . . . , M−1, where 0≤i<M.

A multidimensional segment with dimension M may be defined as a segment representing the information regarding samples in space starting at point S=[s₀, s₁, . . . s_{M-1}] and length D=[d₀, d₁, . . . d_{M-1}], where sᵢ and dᵢ are non-negative integer numbers. If non-integer values are needed, then vector T=[t₀, t₁, . . . , T_{M-1}] may represent the scale factor t, for dimension i, in which the actual starting point and length in the dimension i are sᵢ/tᵢ, and dᵢ/tᵢ respectively, where t, may be a positive integer number.

Table 1 illustrates an example byte format for location metadata for a single segment.

TABLE 1

| | Name of | | | Number |
|---|---|---|---|---|
| | Parameter | Definition | Type | of bytes |
| M times | scale t₀ | scale of the dimension 0 (time) | Unsigned | 4 |
| | | | integer | |
| | scale t₁ | scale of the dimension 1 | Unsigned | 4 |
| | | | integer | |
| | . . . | . . . | . . . | . . . |
| | scale t_{M-1} | scale of the dimension M − 1 | Unsigned | 4 |
| | | | integer | |
| M times | scale s₀ | start position of the dimension 0 | Unsigned | 4 |
| | | (time) | integer | |
| | scale s₁ | start position of the dimension 1 | Unsigned | 4 |
| | | | integer | |
| | . . . | . . . | . . . | . . . |
| | scale s_{M-1} | start position of the dimension | Unsigned | 4 |
| | | M − 1 | integer | |
| M times | length d₀ | length of the dimension 0 | Unsigned | 4 |
| | | (duration) | integer | |
| | length d₁ | length of the dimension 1 | Unsigned | 4 |
| | | | integer | |
| | . . . | . . . | . . . | . . . |
| | length d_{M-1} | length of the dimension M − 1 | Unsigned | 4 |
| | | | integer | |
| | size | Size of segment | Unsigned | 4 |
| | | The default value is ‘false” | integer | |

The table may be repeated for additional segments by one or more concatenation of the same table: Table 1, Table 1, . . . , Table 1 for multiple segments.

Table 2 shows an example byte format for the sequence metadata of a single segment. In some embodiments, since the startcode C is common in all segments (e.g., same startcode in all segments), the startcode C is not carried as part of the sequence metadata and has its own input to a function.

TABLE 2

| | Name of | | | Number |
|---|---|---|---|---|
| | Parameter | Definition | Type | of bytes |
| M times | sequence n₀ | sequence number of the | Unsigned | 4 |
| | | dimension 0 (time) | integer | |
| | sequence n₁ | sequence number of the | Unsigned | 4 |
| | | dimension 1 | integer | |
| | . . . | . . . | . . . | . . . |
| | sequence n_{M-1} | sequence number of the | Unsigned | 4 |
| | | dimension M − 1 | integer | |
| | size | Size of segment | Unsigned | 4 |
| | | The default value is ‘false” | integer | |

The table may be repeated for additional segments by one or more concatenations of the same Table 2: Table 2, Table 2, . . . , Table 2 for multiple segments.

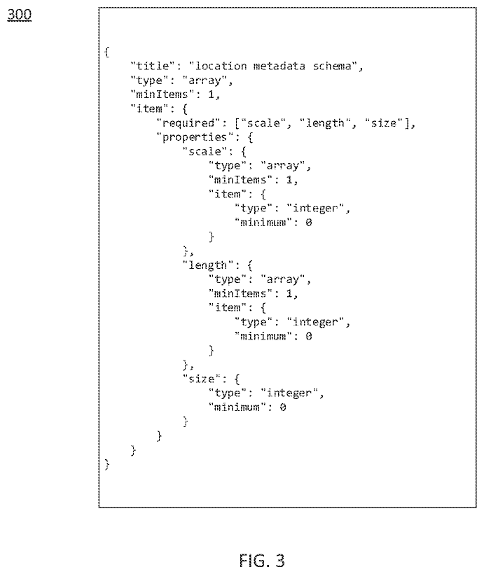

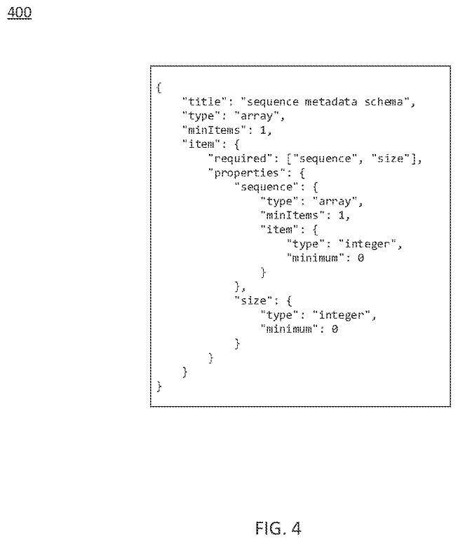

FIG. 3 illustrates an example JSON object (300) for the location metadata for one or more segments. FIG. 4 illustrates an example JSON object (400) for the sequence metadata for one or more segments. In some embodiments, since the startcode C may be common in all segments, the startcode C may not be carried as part of the sequence metadata and has its input to a function.

Table 3 illustrates an example MIME type for each wire format (e.g., byte format and JSON object).

TABLE 3

| | Metadata | |
|---|---|---|
| Format | type | MIME Type |
| Byte format | Location | application/mpeg-nbmp-segment- |
| | | metadata-location |
| Byte format | Sequence | application/mpeg-nbmp-segment- |
| | | metadata-sequence |
| JSON | Location | application/mpeg-nbmp-segment- |
| | | metadata-location+json |
| JSON | Sequence | application/mpeg-nbmp-segment- |
| | | metadata-sequence+json |

Table 4 shows example extended step descriptor parameters to signal the supported formats by a function in its function description document (FDD). The underlined row is a new parameter.

| | | | | Valid |
|---|---|---|---|---|
| Name | Definition | Unit | Type | range |
| step-mode | Running mode with the following values: | N/A | string | N/A |
| | ‘stream’: continuous execution | | | |
| | ‘stateful’: maintain the state of tasks | | | |
| | at end each step | | | |
| | ‘stateless’: run in stateless mode | | | |
| | without the need for maintaining state | | | |
| | The default value is ‘stream’. | | | |
| segment-duration | duration for which the output(s) of | microseconds | number | unsigned |
| | resource are independent of any inputs | | | integer |
| | outside of the corresponding duration. | | | |
| operation-units | number of segment-duration the resource | N/A | number | unsigned |
| | is operating in a stateless fashion | | | integer |
| segment-location | If ‘true’, this function supports receiving | N/A | boolean | N/A |
| | and providing segment metadata | | | |
| | consisting of segment’s start time, | | | |
| | duration and segment byte length (as | | | |
| | input/output metadata) for each media | | | |
| | input/output to detect the segment | | | |
| | boundaries. | | | |
| | The format of segment metadata is | | | |
| | defined in the function input/output | | | |
| | definition. | | | |
| | The default value is ‘false” | | | |
| segment-sequence | If ‘true’, this function supports receiving | N/A | boolean | N/A |
| | and providing a startcode (as input/output | | | |
| | metadata) for each media input/output to | | | |
| | detect the segment boundaries. Each | | | |
| | input/output has a segment metadata that | | | |
| | defines the sequence number for each | | | |
| | segment. The sequence number shall be | | | |
| | unique integer and indicate the location | | | |
| | of the segment in the stream. | | | |
| | The format of segment metadata is | | | |
| | defined in the function input/output | | | |
| | definition. | | | |
| | The default value is ‘false” | | | |
| se gment-metadata- | lists the supported formats for segment- | N/A | Array | N/A |
| supported-formats | metadata and segment-startcodes: | | of | |
| | ‘nbmp-locati on-bytestream-2022’: | | strings | |
| | bytestream format defined in Table | | | |
| | XYXY1. | | | |
| | 'nbmp-sequence-bytestream-2022': | | | |
| | bytestream format defined in Table | | | |
| | XYXY2 | | | |
| | ‘nbmp-location-json-2022’: JSON | | | |
| | format defined in Table XYXY3. | | | |
| | ‘nbmp-sequence-json-2022’: JSON | | | |
| | format defined in Table XYXY4. | | | |
| temporal-overlap | determines the size of overlap between | N/A | number | unsigned |
| | segments. | | | integer |
| | The default value is 0. | | | |
| number-of- | number of dimensions of a segment other | N/A | number | unsigned |
| dimension | than temporal. The default value is 0. | | | integer |
| high-dimension- | array defining the divisors of the segment | varies | Array | unsigned |
| segment-divisors | in the higher dimensions. Each element is | *see the | of | integer |
| | an unsigned non-zero integer. | description | number | |
| | *The unit of divisor in each dimension | | | |
| | depends on the unit of media on that | | | |
| | dimension. For instance, the unit for | | | |
| | spatial dimensions is the pixel, and the | | | |
| | unit for color components is the color | | | |
| | component index. The array size is equal | | | |
| | to ‘number-of-dimensions’. | | | |
| higher-dimensions- | description of each other dimensions. The | N/A | Array | N/A |
| descriptions | array size is equal to ‘number-of- | | of | |
| | dimensions’. Each element is a string. | | string | |
| | The following values are defined in this | | | |
| | document: | | | |
| | ‘width’: width of the video frame | | | |
| | ‘height’: height of the video frame | | | |
| | ‘RGB’: color components R, G, | | | |
| | and B, where R, G, and B | | | |
| | components are defined by index | | | |
| | 0, 1, and 2 respectively. | | | |
| | ‘depth’: image (not a depth map) | | | |
| | and depth-map*, where image and | | | |
| | depth-map are defined by index 0, | | | |
| | 1, and 2 respectively. | | | |
| | ‘YUV‘: color components Y, U, | | | |
| | V where Y, U, and V components | | | |
| | are defined by index 0, 1, and 2 | | | |
| | respectively. | | | |
| | ‘V-PCC’: V-PCC components | | | |
| | patch, geometry, occupancy, and | | | |
| | attribute, where patch, geometry, | | | |
| | occupancy, and attribute are | | | |
| | defined by index 0, 1,2, and 3 | | | |
| | respectively. | | | |
| higher-dimensions- | The split/merge order for segments of the | Unsigned | Array | N/A |
| segment-order | same time instance. The array shows the | integer | of | |
| | order of different dimensions. The value | | number | |
| | is an array element is the dimension | | | |
| | index starting from zero. A dimension | | | |
| | located in the array’s element n+1 is | | | |
| | nested in the dimension located in the | | | |
| | array element n. | | | |
| | The array size is equal to ‘number-of- | | | |
| | dimensions’. | | | |
| higher-dimension- | The size of overlap at each dimension | Unsigned | Array | N/A |
| overlap | other than temporal. The array size is | integer | of | |
| | equal to ‘number-of-dimensions’. Each | | number | |
| | element is an unsigned integer. When the | | | |
| | given overlap value is greater than the | | | |
| | size of the segment, the original data shall | | | |
| | be used than the segment. | | | |
| higher-dimension- | The number of segments of the resource | Unsigned | Array | N/A |
| operation-units | in each dimension for operating in a | integer | of | |
| | stateless fashion. The array size is equal | | number | |
| | to ‘number-of-dimensions‘. Each element | | | |
| | is an unsigned nonzero integer. | | | |
| | The default value is an array of 1 s. | | | |

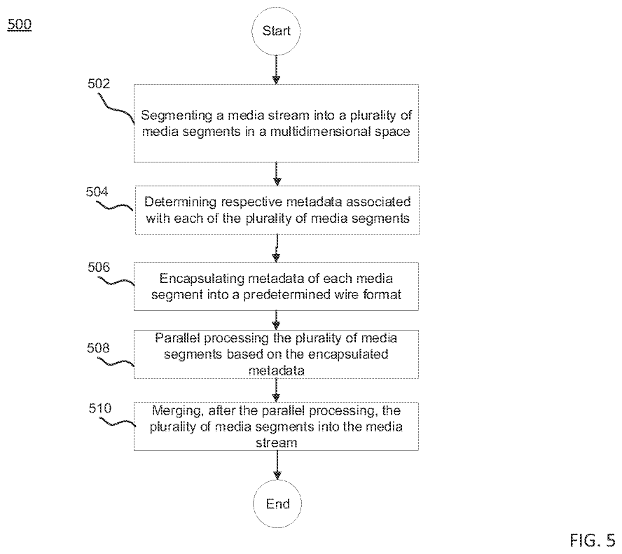

FIG. 5 illustrates a flow chart of an embodiment of a process (500) for segmenting and processing a media stream using a wire format for the media stream metadata. The process (500) may start at operation (502) where a media stream is segmented into a plurality of media segments. The process proceeds to operation (504) where respective metadata associated with each of the plurality of media segments is determined. The process proceeds to operation (506) where metadata of each media segment is encapsulated into a predetermined wire format such as the byte format or the JSON format. The metadata may be the location metadata or the sequence metadata. The metadata may include a location or sequence associated with each of the plurality of media segments. The process proceeds to operation (508) where the plurality of media segments are processed in parallel based on the encapsulated metadata. The process proceeds to operation (510) where after the parallel processing, the plurality of media segments are merged into the media stream.

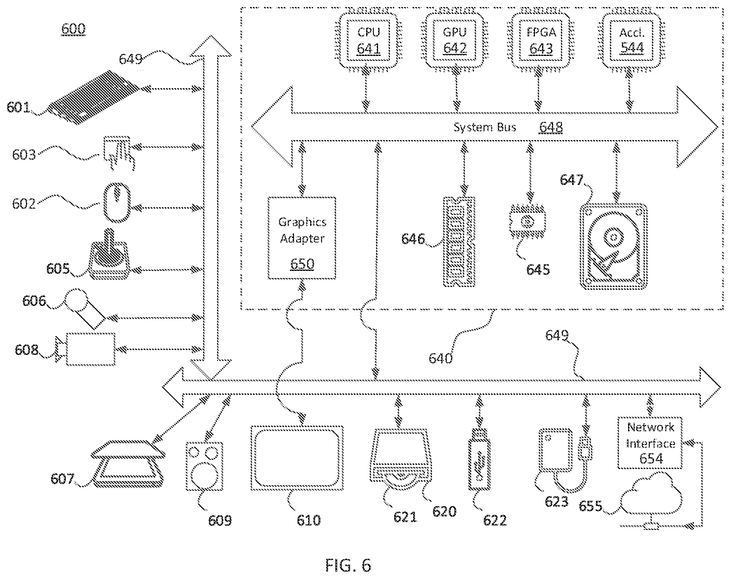

The techniques of embodiments of the present disclosure described above, may be implemented as computer software using computer-readable instructions and physically stored in one or more computer-readable media. For example, FIG. 6 shows a computer system (600) suitable for implementing embodiments of the disclosed subject matter.

The computer software may be coded using any suitable machine code or computer language, that may be subject to assembly, compilation, linking, or like mechanisms to create code comprising instructions that may be executed directly, or through interpretation, micro-code execution, and the like, by computer central processing units (CPUs), Graphics Processing Units (GPUs), and the like.

The instructions may be executed on various types of computers or components thereof, including, for example, personal computers, tablet computers, servers, smartphones, gaming devices, internet of things devices, and the like.

The components shown in FIG. 6 for computer system (600) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (600).

Computer system (600) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices may also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (601), mouse (602), trackpad (603), touch screen (610), data-glove, joystick (605), microphone (606), scanner (607), and camera (608).

Computer system (600) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (610), data-glove, or joystick (605), but there may also be tactile feedback devices that do not serve as input devices). For example, such devices may be audio output devices (such as: speakers (609), headphones (not depicted)), visual output devices (such as screens (610) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system (600) may also include human accessible storage devices and their associated media such as optical media including CD/DVD ROM/RW (620) with CD/DVD or the like media (621), thumb-drive (622), removable hard drive or solid state drive (623), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (600) may also include interface to one or more communication networks. Networks may for example be wireless, wireline, optical. Networks may further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (649) (such as, for example USB ports of the computer system (600); others are commonly integrated into the core of the computer system (600) by attachment to a system bus as described below (for example Ethernet interface into a PC computer system or cellular network interface into a smartphone computer system). Using any of these networks, computer system (600) may communicate with other entities. Such communication may be uni-directional, receive only (for example, broadcast TV), uni-directional send-only (for example CANbus to certain CANbus devices), or bi-directional, for example to other computer systems using local or wide area digital networks. Such communication may include communication to a cloud computing environment (655). Certain protocols and protocol stacks may be used on each of those networks and network interfaces as described above.

Aforementioned human interface devices, human-accessible storage devices, and network interfaces (654) may be attached to a core (640) of the computer system (600).

The core (640) may include one or more Central Processing Units (CPU) (641), Graphics Processing Units (GPU) (642), specialized programmable processing units in the form of Field Programmable Gate Areas (FPGA) (643), hardware accelerators (644) for certain tasks, and so forth. These devices, along with Read-only memory (ROM) (645), Random-access memory (646), internal mass storage such as internal non-user accessible hard drives, SSDs, and the like (647), may be connected through a system bus (648). In some computer systems, the system bus (648) may be accessible in the form of one or more physical plugs to enable extensions by additional CPUs, GPU, and the like. The peripheral devices may be attached either directly to the core's system bus (648), or through a peripheral bus (649). Architectures for a peripheral bus include PCI, USB, and the like. A graphics adapter (650) may be included in the core (640).

CPUs (641), GPUs (642), FPGAs (643), and accelerators (644) may execute certain instructions that, in combination, may make up the aforementioned computer code. That computer code may be stored in ROM (645) or RAM (646). Transitional data may be also be stored in RAM (646), whereas permanent data may be stored for example, in the internal mass storage (647). Fast storage and retrieve to any of the memory devices may be enabled through the use of cache memory, that may be closely associated with one or more CPU (641), GPU (642), mass storage (647), ROM (645), RAM (646), and the like.

The computer readable media may have computer code thereon for performing various computer-implemented operations. The media and computer code may be those specially designed and constructed for the purposes of the present disclosure, or they may be of the kind well known and available to those having skill in the computer software arts.

As an example and not by way of limitation, the computer system having architecture (600), and specifically the core (640) may provide functionality as a result of processor(s) (including CPUs, GPUs, FPGA, accelerators, and the like) executing software embodied in one or more tangible, computer-readable media. Such computer-readable media may be media associated with user-accessible mass storage as introduced above, as well as certain storage of the core (640) that are of non-transitory nature, such as core-internal mass storage (647) or ROM (645). The software implementing various embodiments of the present disclosure may be stored in such devices and executed by core (640). A computer-readable medium may include one or more memory devices or chips, according to particular needs. The software may cause the core (640) and specifically the processors therein (including CPU, GPU, FPGA, and the like) to execute particular processes or particular parts of particular processes described herein, including defining data structures stored in RAM (646) and modifying such data structures according to the processes defined by the software. In addition or as an alternative, the computer system may provide functionality as a result of logic hardwired or otherwise embodied in a circuit (for example: accelerator (644)), which may operate in place of or together with software to execute particular processes or particular parts of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

The foregoing disclosure provides illustration and description, but is not intended to be exhaustive or to limit the implementations to the precise form disclosed. Modifications and variations are possible in light of the above disclosure or may be acquired from practice of the implementations.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium may be a tangible device that may retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

The above disclosure also encompasses the embodiments listed below:

(1) A method performed by at least one processor, the method including: segmenting a media stream into a plurality of media segments in a multidimensional space; determining respective metadata associated with each of the plurality of media segments; encapsulating a plurality of metadata into a predetermined wire format, each encapsulated metadata comprising a location or sequence associated with the each of the plurality of media segments; parallel processing the plurality of media segments based on the encapsulated metadata; and merging, after the parallel processing, the plurality of media segments into the media stream.

(2) The method of feature (1), in which metadata of each media segment from the plurality of media segments includes location metadata.

(3) The method of feature (2), in which the predetermined wire format includes a byte stream format, and in which one or more of a multidimensional scale vector, a location vector, a length vector, and size information are encapsulated in the byte stream format.

(4) The method of feature (2), in which the predetermined wire format is a JSON array, and in which one or more of a multidimensional scale vector, a location vector, a length vector, and size information are encapsulated in array elements for the plurality of media segments.

(5) The method of feature (1), in which metadata of each media segment from the plurality of media segments includes sequence metadata.

(6) The method of feature (5), in which the predetermined wire format is a byte stream format, and in which one or more of a multidimensional sequence vector and size information are encapsulated in the byte stream format.

(7) The method of feature (5), in which the predetermined wire format is a JSON array, and in which one or more of a multidimensional sequence vector and size information are encapsulated in array elements for the plurality of media segments.

(8) The method of feature (1), in which the predetermined wire format includes a multipurpose internet mail extension (MIME).

(9) An apparatus includes at least one memory configured to store computer program code; and at least one processor configured to read the computer program code and operate as instructed by the computer program code, the computer program code including: segmenting code configured to cause the at least one processor to segment a media stream into a plurality of media segments in a multidimensional space, determining code configured to cause the at least one processor to determine respective metadata associated with each of the plurality of media segments, encapsulating code configured to cause the at least one processor to encapsulate a plurality of metadata into a predetermined wire format, each encapsulated metadata comprising a location or sequence associated with the each of the plurality of media segments, parallel processing code configured to cause the at least one processor to parallel process the plurality of media segments based on the encapsulated metadata, and merging code configured to cause the at least one processor to merge, after the parallel processing, the plurality of media segments into the media stream.

(10) The apparatus of feature (9), in which metadata of each media segment from the plurality of media segments includes location metadata.

(11) The apparatus of feature (10), in which the predetermined wire format includes a byte stream format, and in which one or more of a multidimensional scale vector, a location vector, a length vector, and size information are encapsulated in the byte stream format.

(12) The apparatus of feature (10), in which the predetermined wire format is a JSON array, and in which one or more of a multidimensional scale vector, a location vector, a length vector, and size information are encapsulated in array elements for the plurality of media segments.

(13) The apparatus of feature (9), in which metadata of each media segment from the plurality of media segments includes sequence metadata.

(14) The apparatus of feature (13), in which the predetermined wire format is a byte stream format, and in which one or more of a multidimensional sequence vector and size information are encapsulated in the byte stream format.

(15) The apparatus of feature (13), in which the predetermined wire format is a JSON array, and in which one or more of a multidimensional sequence vector and size information are encapsulated in array elements for the plurality of media segments.

(16) The apparatus of feature (9), in which the predetermined wire format includes a multipurpose internet mail extension (MIME).

(17) A non-transitory computer readable medium having instructions stored therein, which when executed by a processor cause the processor to execute a method including: segmenting a media stream into a plurality of media segments in a multidimensional space; determining respective metadata associated with each of the plurality of media segments; encapsulating a plurality of metadata into a predetermined wire format, each encapsulated metadata comprising a location or sequence associated with the each of the plurality of media segments; parallel processing the plurality of media segments based on the encapsulated metadata; and merging, after the parallel processing, the plurality of media segments into the media stream.

(18) The non-transitory computer readable medium of feature (17), in which metadata of each media segment from the plurality of media segments includes location metadata.

(19) The non-transitory computer readable medium of feature (18), in which the predetermined wire format includes a byte stream format, and in which one or more of a multidimensional scale vector, a location vector, a length vector, and size information are encapsulated in the byte stream format.

(20) The non-transitory compute readable medium of feature (18), in which the predetermined wire format is a JSON array, and in which one or more of a multidimensional scale vector, a location vector, a length vector, and size information are encapsulated in array elements for the plurality of media segments.

What is claimed is:

1. A method performed by at least one processor, the method comprising:
segmenting a media stream into a plurality of media segments in a multidimensional space;
determining respective metadata associated with each of the plurality of media segments;
encapsulating a plurality of metadata into a predetermined wire format, each encapsulated metadata comprising a location or sequence associated with the each of the plurality of media segments;
parallel processing the plurality of media segments based on the encapsulated metadata; and
merging, after the parallel processing, the plurality of media segments into the media stream.

2. The method of claim 1, wherein metadata of each media segment from the plurality of media segments includes location metadata.

3. The method of claim 2, wherein the predetermined wire format includes a byte stream format, and wherein one or more of a multidimensional scale vector, a location vector, a length vector, and size information are encapsulated in the byte stream format.

4. The method of claim 2, wherein the predetermined wire format is a JSON array, and wherein one or more of a multidimensional scale vector, a location vector, a length vector, and size information are encapsulated in array elements for the plurality of media segments.

5. The method of claim 1, wherein metadata of each media segment from the plurality of media segments includes sequence metadata.

6. The method of claim 5, wherein the predetermined wire format is a byte stream format, and wherein one or more of a multidimensional sequence vector and size information are encapsulated in the byte stream format.

7. The method of claim 5, wherein the predetermined wire format is a JSON array, and wherein one or more of a multidimensional sequence vector and size information are encapsulated in array elements for the plurality of media segments.

8. The method of claim 1, wherein the predetermined wire format includes a multipurpose internet mail extension (MIME).

9. An apparatus comprising:
at least one memory configured to store computer program code; and
at least one processor configured to read the computer program code and operate as instructed by the computer program code, the computer program code comprising:
segmenting code configured to cause the at least one processor to segment a media stream into a plurality of media segments in a multidimensional space,
determining code configured to cause the at least one processor to determine respective metadata associated with each of the plurality of media segments,
encapsulating code configured to cause the at least one processor to encapsulate a plurality of metadata into a predetermined wire format, each encapsulated metadata comprising a location or sequence associated with the each of the plurality of media segments,
parallel processing code configured to cause the at least one processor to parallel process the plurality of media segments based on the encapsulated metadata, and
merging code configured to cause the at least one processor to merge, after the parallel processing, the plurality of media segments into the media stream.

10. The apparatus of claim 9, wherein metadata of each media segment from the plurality of media segments includes location metadata.

11. The apparatus of claim 10, wherein the predetermined wire format includes a byte stream format, and wherein one or more of a multidimensional scale vector, a location vector, a length vector, and size information are encapsulated in the byte stream format.

12. The apparatus of claim 10, wherein the predetermined wire format is a JSON array, and wherein one or more of a multidimensional scale vector, a location vector, a length vector, and size information are encapsulated in array elements for the plurality of media segments.

13. The apparatus of claim 9, wherein metadata of each media segment from the plurality of media segments includes sequence metadata.

14. The apparatus of claim 13, wherein the predetermined wire format is a byte stream format, and wherein one or more of a multidimensional sequence vector and size information are encapsulated in the byte stream format.

15. The apparatus of claim 13, wherein the predetermined wire format is a JSON array, and wherein one or more of a multidimensional sequence vector and size information are encapsulated in array elements for the plurality of media segments.

16. The apparatus of claim 9, wherein the predetermined wire format includes a multipurpose internet mail extension (MIME).

17. A non-transitory computer readable medium having instructions stored therein, which when executed by a processor cause the processor to execute a method comprising:
segmenting a media stream into a plurality of media segments in a multidimensional space;
determining respective metadata associated with each of the plurality of media segments;
encapsulating a plurality of metadata into a predetermined wire format, each encapsulated metadata comprising a location or sequence associated with the each of the plurality of media segments;
parallel processing the plurality of media segments based on the encapsulated metadata; and
merging, after the parallel processing, the plurality of media segments into the media stream.

18. The non-transitory computer readable medium of claim 17, wherein metadata of each media segment from the plurality of media segments includes location metadata.

19. The non-transitory computer readable medium of claim 18, wherein the predetermined wire format includes a byte stream format, and wherein one or more of a multidimensional scale vector, a location vector, a length vector, and size information are encapsulated in the byte stream format.

20. The non-transitory compute readable medium of claim 18, wherein the predetermined wire format is a JSON array, and wherein one or more of a multidimensional scale vector, a location vector, a length vector, and size information are encapsulated in array elements for the plurality of media segments.
